(19) United States
(12) Patent Application Publication
(10) Pub. No.: US 2014/0270116 A1
(43) Pub. Date: Sep. 18, 2014

(54) SYSTEM AND METHOD FOR DELIVERING A TARGETED MESSAGE TO A CALLING PARTY

(71) Applicant: VONAGE NETWORK LLC, Holmdel, NJ (US)

(72) Inventor: TZAHI EFRATI, Hoboken, NJ (US)

(73) Assignee: VONAGE NETWORK LLC, Holmdel, NJ (US)

(21) Appl. No.: 13/804,969

(22) Filed: Mar. 14, 2013

(51) Int. Cl. H04M 3/51

(52) U.S. Cl. CPC H04M 3/51
USPC 379/88.13

(57) ABSTRACT

A system and method performed by a telephony system for delivering a targeted message to a calling party is disclosed. The system and method includes receiving a request for communication originating from a calling device and directed to a recipient and accessing a contact history associated with the calling device. The system and method further includes selecting, based at least in part upon the contact history, a targeted message associated with the recipient and based on the communication and the contact history and providing the targeted message to the calling device.

### BACKGROUND OF THE INVENTION

The invention is related to telephony systems. More specifically, the invention is related to systems and methods for delivering a targeted message to a calling party.

A customer may call a business, for example, to place an order or inquire about a product or service. However, generally, the business may have very little information about the customer prior to receiving the call. Likewise, the business may not have procedures to follow up with the customer in order to maintain and manage a relationship with the customer.

In order to efficiently develop and manage customer relationships, it would be advantageous for businesses to have the ability to send tailored messages to their customers. More specifically, when a business receives a communication from a customer such as a call, it would be advantageous if the business had access to information about the calling customer so as to be able to select and send a message tailored to the preferences of the customer.

Thus, there is a need for systems and methods which can analyze incoming calls or other communications and determine an appropriate message specific to the called party to send to the calling party that is targeted to the calling party.

### SUMMARY OF THE INVENTION

In one exemplary embodiment, a method performed by a telephony system for delivering a targeted message from a called party to a calling party is disclosed. The method includes receiving a communication directed to the called party through a provider network and accessing a contact history associated with the calling party. The method further includes selecting, based at least in part upon the contact history, a targeted message associated with the called party and providing the targeted message to the calling party.

In another exemplary embodiment, a telephony system for delivering a targeted message from a called party to a calling party is disclosed. The system includes a provider network for receiving a communication directed to the calling party from a calling party. The provider network is communicatively connected to both the calling party and the called party. One or more non-transitory computer readable storage mediums contain a contact history database and a targeted messages database. A processing unit on the provider network accesses and analyzes information associated with the calling party in the contact history database to select a targeted message associated with the called party from the targeted messages database. The processing instructs the provider network to provide the targeted message to the calling party.

### BRIEF DESCRIPTION OF THE DRAWINGS

FIG. 1 is a diagram of a communications environment including various elements which are associated with a system for delivering a targeted message to a calling party in accordance with the invention;

FIG. 2 is an illustration of a block diagram in accordance with one embodiment of the present invention of elements that form part of a system on a provider network; and

FIG. 3 is a flow chart illustrating steps of a method for delivering a targeted message to a calling party.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

As illustrated in an exemplary embodiment shown in FIG. 1, a block diagram 100 representing a communication environment for delivering a targeted message to a calling party is provided. A communication such as a call from a caller client device 101 is connected to the called party 105 through a provider network 103. The caller client device 101 includes but is not limited to telephones calling via a Public Switched Telephone Network (PSTN) or connected over a Voice Over Internet Protocol (VoIP) network, cell phones or other devices that can send and receive calls on a telephony network. The called party 105 may be, for example, a retail business which may receive calls, orders or in-person visits from potential and existing customers. The provider network 103 is in communication with database 102 which contains a contact history of the calling party and database 104 which contains targeted messages associated with called party 105.

In one exemplary embodiment the call may be in a communication medium other than a voice or audio call. The communication medium may include text, email or video, for example.

The invention is sometimes disclosed with reference to advertising. However, its principles are applicable to many forms of communication where information directed to a customer or contact can be personalized or targeted, e.g., a community of church members or a school group. In such groups, a common denominator of mutual interest provides sufficient incentive to focus the content presented to the group.

Databases 102 and 104 reside on computer-readable medium, which may be one or more of readily available memory such as random access memory (RAM), read only memory (ROM), floppy disk, hard disk, flash memory or any other form of digital storage, local or remote, and is preferably of non-volatile nature.

Referring to FIG. 2, elements of a provider network 200 are shown, including a processing unit 202 that may be used to provide various functions of the provider network including the methods discussed herein. The provider network 200 may contain multiple processing units, databases and other elements and FIG. 2 is presented only as an illustration of an exemplary embodiment of the present invention.

Processing unit 202 is in communication with a contact history database 102 and a targeted message database 104 which may store and modify messages to be sent to the calling party. The contact history database 102 and the targeted messages database 104 may, but need not, reside on the provider network and optionally may be remotely accessible.

The processing unit 202 shown may be one of any form of a general purpose computer processor used in processing data in a provider network. The processing unit 202 comprises a central processing unit (CPU) 204, and support circuits 203 for the CPU 204 and memory 201. The processing unit 202 also includes provisions for connecting the processing unit 202 to customer equipment, to service provider equipment and IP network or gateways, as well as possibly one or more input/output devices (not shown) for accessing the processing unit and/or performing ancillary or administrative functions related thereto.

The support circuits 203 and the CPU 204 for supporting the processing unit 202 are connected in a conventional manner. These circuits include cache, power supplies, clock circuits, input/output circuitry and subsystems, and the like.

The contact history may include, for example, information about the calling party collected from or provided by third-party sources such as social media platforms; information regarding whether the calling party has called the business before; prior activity of the calling party, including internet usage history (whether on the called party's website or otherwise); current activity of the calling party, including mobile application usage; capabilities of the calling party's device; the geographic location of the caller; and the communication medium (e.g., video calling, audio calling) being used by the caller. The contact history may also include a history of calls that the caller has made to competitors of called party 105. The contact history may contain activity data associated with the caller gathered across multiple devices, platforms and networks. This activity data may include but is not limited to internet access history, music, videos, games, texting and chatting. Moreover, location can be tracked by a global positioning system (GPS), cell tower proximity or triangulation, or WiFi hot spot proximity based on the caller client device, laptop computer or other devices. In addition, current activity may be included in the contact history from an event calendar. A caller may maintain appointments and events in an electronic calendar. Appointments and events may include for example, sports events, doctor appointments, holidays and the like.

A computer program or software routine 210 when executed by the CPU 204, causes the processing unit 202 to perform processes of the disclosed embodiments, and is generally stored in a memory or computer-readable medium, which may be one or more of readily available memory such as random access memory (RAM), read only memory (ROM), floppy disk, hard disk, flash memory or any other form of digital storage, local or remote, and is preferably of non-volatile nature. Also, the software routines could also be stored remotely from the CPU 204. For example, the software could be resident on servers and memory devices that are located remotely from the CPU 204, but which are accessible to the CPU 204 via a data network connection.

The computer program or software routine 210, when executed by the CPU 204, transforms the general purpose computer into a specific purpose computer that performs one or more functions of the methods and systems of the disclosed embodiments. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine of the disclosed embodiments is capable of being executed on any computer operating system, and is capable of being performed using any CPU architecture.

FIG. 3 depicts a flowchart illustrating steps of a method of delivering targeted messages from a called party to a calling party. In one embodiment of the invention, a call directed to the called party 105 is initiated at step S301 and is received at provider network 103 at step S302. When the call is received (S302) at the provider network 103, the processing unit 202 identifies the caller at step S303 by the caller phone number or other identifying credentials. The processing unit 202 accesses the caller contact history from contact history database 102 at step S304. At step S305 the processing unit 202 selects an appropriate message from targeted messages database 104 associated with the called party and based on the contact history. The processing unit 202 instructs the provider network 103 to transmit the appropriate message to the caller client device 101 at step S306. The message transmission S306 may occur during the call, before the communication is requested or following the termination of the call. The message is sent (S306) to the caller client device 101 from the provider network 200 in an appropriate communication medium in return. The return communication medium may include still images, audio, video and text.

In some instances, the information or message sent is delivered to the called party as text. This typically means causing the text to be displayed to the called party on a display screen of the caller client device. In other instances, the information or message could comprise an audio or a video recording.

In other embodiments, the information or message from the business to the caller may be in the form of a coupon to attract new customers.

In yet other embodiments, the message may be tailored to preferences determined from a customer profile that will alert the caller to a special or product that is appropriate to the customer preferences based on the customer profile.

In another embodiment, the message may be targeted to a product or service of the business that is related to products or services the customer has inquired about from a competitor business. For example, if a customer has an interest in a product category of a competitor in an illustrative embodiment, the system and method can select and send a message in the same product category from the called business.

In other embodiments the call to the business may be in a form other than a voice or audio call. The call may include text, email or video, for example.

The method described above with reference to FIG. 3 is performed transparent to the caller and without interfering with the communication between the customer 101 and business 105.

The above described system and method may be any telephony device including IP telephony devices and certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

The descriptions herein also refer to telephony communications and telephony activity. These terms are intended to encompass all types of telephone communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

In the methods and systems described herein, references are made to calls between a customer and a business. Although the term “call” is used in this description, the systems and methods described herein could also be used to connect two parties to other forms of telephony communications. Thus, the references to a “call” are in no way to be considered limiting.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method performed by a telephony system for delivering a targeted message to a calling party, comprising:
receiving a request for communication originating from a calling device and directed to a recipient;
accessing a contact history associated with the calling device;
selecting, based at least in part upon the contact history, a targeted message associated with the recipient; and
providing the targeted message to the calling device.

2. The method of claim 1, wherein the contact history comprises a history of prior contact between an identifier associated with the calling device and the called party.

3. The method of claim 1, wherein the contact history is based on at least one of past activity, current usage, geographic location and communication medium.

4. The method of claim 1, wherein the contact history is based on communication activity to a competitor business.

5. The method of claim 1, wherein the targeted message comprises a still image, video, audio or text.

6. The method of claim 1, wherein the request for communication is for a communication comprising audio, text, email or video.

7. The method of claim 1, wherein providing the targeted message occurs while the calling device and the recipient are engaged in the requested communication.

8. The method of claim 1, wherein providing the targeted message occurs prior to the requested communication.

9. A telephony system for delivering a targeted message to a calling party, comprising:
a contact history database;
a targeted messages database; and
a provider network that is configured to:
receive a request for communication originating from the calling device and directed to a recipient;
access a contact history associated with the calling device in the contact history database;
select from the targeted messages database, based at least in part upon the contact history, a targeted message associated with the recipient; and
provide the targeted message to the calling device.

10. The system of claim 9, wherein the contact history comprises a history of prior contact between an identifier associated with the calling device and the called party.

11. The system of claim 9, wherein the contact history includes past activity, current usage, geographic location and communication media.

12. The system of claim 9, wherein the contact history includes activity of communications to a competitor business.

13. The system of claim 9, wherein the targeted message comprises a still image, video, audio or text.

14. The system of claim 9, wherein the communication comprises audio, email, text or video.

15. The system of claim 9, wherein providing the targeted message occurs while the calling device and the recipient are engaged in the requested communication.

16. The system of claim 9, wherein providing the targeted message occurs prior to the requested communication.

17. A tangible non-transitory computer readable storage medium containing a computer program, the computer program comprising instructions that when executed by a processing unit cause the processing unit to perform a function, the computer program further comprising:
receiving a request for communication originating from a calling device and directed to a recipient;
accessing a contact history associated with the calling device;
selecting, based at least in part upon the contact history, a targeted message associated with the recipient; and
providing the targeted message to the calling device.
